(19) United States
(12) Patent Application Publication
(10) Pub. No.: US 2026/0244734 A1
(43) Pub. Date: Aug. 20, 2026

(54) AUTOMATED DEPLOYMENT TO ISOLATED NETWORK

(71) Applicant: Lemon Inc., Grand Cayman (KY)

(72) Inventors: Suyash Singh, Wilmington, DE (US); Soma Ray, Wilmington, DE (US); Anup Vasudeo Upadhye, Wilmington, DE (US)

(21) Appl. No.: 19/057,642

(22) Filed: Feb. 19, 2025

(51) Int. Cl. G06F 21/53; G06F 8/61; G06F 8/71; G06F 11/3604; G06F 21/57

(52) U.S. Cl. CPC G06F 21/53; G06F 8/62; G06F 8/71; G06F 11/3604; G06F 21/572

(57) ABSTRACT

The present disclosure involves methods, apparatus, and systems for deployment to an isolated computing environment. This can include identifying a deployment request, the deployment request comprising candidate code for deployment in an isolated computing environment; performing a compliance check on the candidate code; performing an error analysis on the candidate code; identifying approved candidate code; and deploying the candidate code in the isolated computing environment.

### TECHNICAL FIELD

The present disclosure generally relates to automated deployment of software in an isolated network.

### BACKGROUND

Software deployment involves several steps, including building the software, performing testing, packaging the application, and releasing it to the target environment. Deployment strategies vary depending on the application type, target environment, and development methodology. Common approaches include manual deployments, continuous integration and continuous delivery (CI/CD) pipelines, and infrastructure-as-code techniques. Successful software deployment requires planning, testing, and a well-defined process to ensure minimal disruption and stability for the end-users.

### SUMMARY

The present disclosure relates to a method, system, and computer-readable storage media for deployment to an isolated computing environment. This can include identifying a deployment request, the deployment request comprising candidate code for deployment in an isolated computing environment; performing a compliance check on the candidate code; performing an error analysis on the candidate code; identifying approved candidate code; and deploying the candidate code in the isolated computing environment.

Implementations can optionally include one or more of the following features.

In some instances, the isolated computing environment comprises a virtual private cloud (VPC).

In some instances, operations include submitting the candidate code to a human review process, wherein identifying the approved candidate code comprises receiving the approved candidate code from the human review process.

In some instances, operations include: identifying a second deployment request, the second deployment request comprising second candidate code for deployment in the isolated computing environment; performing a second compliance check on the second candidate code; and in response to the second compliance check failing: sending a message to a requesting system associated with the second deployment request, the message indicating a reason for the second compliance check failing; receiving an updated second candidate code for deployment in the isolated computing environment; and performing a third compliance check on the updated second candidate code.

In some instances, the compliance check includes: performing a scan of the candidate code to verify the candidate code will execute entirely within the isolated computing environment, and the scan comprises a search for at least one of uniform resource locators (URLs), table locations, task locations, dependency locations, or target data destinations.

In some instances, the compliance check includes: performing a scan of the candidate code to verify the candidate code does not perform update, replacement, or deletion operations on existing data within the isolated computing environment.

In some instances, the compliance check includes: performing a scan of the candidate code to identify a message that the candidate code will send outside of the isolated computing environment; and verifying that the messages that the code will send only comprises approved information.

In some instances, the approved information includes aggregated, anonymized user data.

In some instances, the compliance check comprises: identifying a user within the isolated computing environment; assigning the user within the isolated computing environment ownership of the candidate code; granting the user within the isolated computing environment permissions associated with the candidate code; and granting the user within the isolated computing environment permissions associated with dependencies of the candidate code.

In some instances, wherein the compliance check comprises: identifying one or more dependencies on which the candidate code relies; determining that at least one of the one or more dependencies is not present in the isolated computing environment; and for each particular dependency not present in the isolated computing environment: submitting a deployment request for the particular dependency.

In some instances, the error analysis comprises: performing a scan of the candidate code for errors; identifying at least one deployment task requiring user input and assigning the task to a user within the isolated computing environment; identifying data that the candidate code will produce and generating a classification recommendation for the identified data; and generating a deployment summary identifying portions of the candidate code that are distinct from pre-approved code.

In some instances, operations include: after deploying the candidate code in the isolated computing environment: identifying a runtime failure of the deployed code; reverting the deployed code to a pre-deployment state; and sending a notification to an entity sending the deployment request, the notification indicating the runtime failure.

According to a second aspect, one or more computer-readable storage media is provided. The one or more computer-readable storage media stores one or more instructions that, when executable by one or more computers, cause the one or more computers to perform the method according to the first aspect or one or more implementations of the first aspect.

According to a third aspect, a computer-implemented system is provided. The computer-implemented system includes one or more computers and one or more computer memory devices interoperably coupled with the one or more computers. The one or more computer memory devices have computer-readable storage media storing one or more instructions that, when executed by the one or more computers, perform the method according to the first aspect or one or more implementations of the first aspect.

While generally described as computer-implemented software embodied on tangible media that processes and transforms the respective data, some or all of the aspects can be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates a block diagram of an example system for automated deployment of software in an isolated network.

FIG. 2 is a flowchart illustrating an example process for automated deployment of software in an isolated network.

FIG. 3 is a flowchart illustrating an example process for performing compliance checks and error analysis of candidate code.

FIG. 4 illustrates a schematic diagram of an example computing system.

Like reference numbers and designations in the various drawings indicate like elements.

### DETAILED DESCRIPTION

This specification relates to methods, apparatuses, and systems for automated deployment of software in an isolated computing environment or network. An isolated computing environment refers to a virtual or physical computing environment, that has a logical and physical separation between the isolated computing environment and its external environment in terms of resources and physical infrastructure. The isolated computing environment and its external environment can be separated by firewalls or other security isolation techniques. Certain isolated, secure, or separate computing environments requires strict controls for content entering and exiting the environment. This ensures safety, privacy, and security of the content within the isolated environment. However, as new software is developed, integrating it or deploying it within an isolated computing environment can be a time-consuming, multi-step process that is susceptible to human error. This disclosure discusses a tool that automates deployment and enables more efficient, accurate, and secure deployment of software within an isolated computing environment while maintaining compliance with the strict controls regarding information entering and exiting the environment.

One example of an isolated computing environment could be an air-gapped computing environment. Air-gapping is a security measure that can involve physically isolating a computer or network from any other network, particularly the internet. This means that the air-gapped system is not connected to any other systems or networks, effectively creating a “gap” of air between it and the outside world. Air-gapping can be used to protect highly sensitive data and critical infrastructure from cyber threats by ensuring that there is no direct electronic connection that could be exploited. Air-gapped environments provide security by being immune to remote hacking attempts and network-based attacks. This makes them ideal for handling highly sensitive data and critical operations. In air-gapped environments, data transfer is controlled and typically requires the use of physical media such as USB drives, CDs, or DVDs. Protocols can be established and followed to verify and sanitize data before it enters the isolated environment, minimizing the risk of introducing vulnerabilities. Air gapping can be employed in environments where security is paramount, such as military systems, financial institutions, critical infrastructure, and research laboratories. While air gapping can significantly enhance security, it can also introduce operational challenges, such as the need for manual data transfers and the complexity of applying updates and patches. These challenges necessitate robust procedures and tools to manage the isolated environment effectively. The proposed solution includes an automated deployment tool designed to streamline the deployment of software within air-gapped environments. This tool reduces the risk of human error, ensures that updates and patches are applied efficiently and securely, and maintains compliance with strict data transfer protocols.

As an example, the disclosed system can receive a deployment request that includes some candidate software to be deployed in the isolated computing environment. The deployment system can then perform automated compliance checks to ensure the security of the isolated computing environment, and an error analysis to improve stability of the isolated computing environment post deployment. In some implementations, a human review and approval process occurs. The deployment tool can deploy the software afterwards. In some implementations after deployment, the software can be monitored, and if a runtime error of failure occurs, the deployment tool can uninstall or roll-back the software to prevent further errors occurring in downstream processes or the isolated computing environment in general.

In one example, the disclosed techniques can be implemented as a tool designed to automate deployment processes, sync information between environments, and manage communication with stakeholders. The tool can be capable of handling high volumes of deployment tasks and reduce the overall time taken for deployments. In some implementations, the disclosed techniques can include one or more of below features:
Automated deployment, for example, by automating more than 99.9% of deployments using application programming interfaces (APIs) for a certain vertical of Data Platform (e.g., LIBRA).
One-Click Deployment, for example, by simplifying the deployment process to a single click, eliminating the need for manual steps. In some implementations, at least one click is needed and intentionally added to ensure the compliance check requirements are satisfied. In some implementations, Compliance requirements can include communication management, or automatically sending notifications to stakeholders and managing responses as well as providing action items directly from communication/messaging platforms.

In some implementations, the disclosed techniques can include features such as API integration which automatically connects with various systems to automate deployment tasks, a notification system that integrates with communication platforms to send updates and notifications, and/or a deployment dashboard which can provide a user-friendly interface for monitoring and managing deployments.

In some implementations, the disclosed techniques allow deploying software based on an example procedure that includes:
1. Initiate Deployment: User initiates the deployment process with a single click.
2. API Calls: The deploy system makes API calls to perform deployment tasks and sync information between environments.
3. Notification: The deploy system sends notifications to stakeholders via messaging service.
4. Completion: Once deployment is complete, the deploy system sends a final notification and updates the deployment dashboard.

In some implementations, the disclosed techniques can achieve one or more the technical effects or advantages such as the automation of deployment processes using APIs, one-click deployment features, the integration with communication platforms for automatic notifications, the elimination of third-party tools such as JIRA for deployment processes, and the ability to handle high volumes of deployment tasks efficiently. In some implementations, the disclosed techniques can reduce the time taken for deployment from days to hours, eliminate most manual steps from the deployment process, manage high volumes of deployments, simplify the human review process, and reduce dependency on third party tools. In some implementations, the disclosed techniques can automatically detect the geographical region of the target deployment environment and enforce all code to be deployed in the target location.

In some implementations, compliance and error checking is automatically performed in order to ensure no data is inserted in tactics, techniques, and procedure (TTP) tables, block certain kinds of queries/code, ensure the messages sent between the isolated computing environment and the external environment do not contain any sensitive information or data, and summarize the deployment. The system can also Recommend the data classification (public data, internal data, personally identifiable information, etc.) which can influence how the data is used or permitted to be used in the isolated computing environment. Error checking can include an automated system that check the code for errors, ensures the ownership lies within the isolated computing environment, and if it doesn't, assigns a team member who is responsible for the task within the isolated computing environment. Error checking can intelligently understand the dependencies of the tasks and deploy them in the order. Additionally, the system can halt or rollback deployments if the first run is not successful, automatically check the credentials of the local owners and permissions.

In some implementations, AI models such as neural networks, and/or machine learning algorithms can be used to automate these processes. Machine learning algorithms can be trained on the specific logs within the isolated computing environment, training models based on more than 400,000 deployments that been accomplished. In some implementations, AI models can be used to auto update the task to resolve the errors before the deployment, if the deployment fails AI models can recommend the errors and best practices.

In some implementations an AI algorithm to auto learns and keeps on improving as the teams work on the compliance.

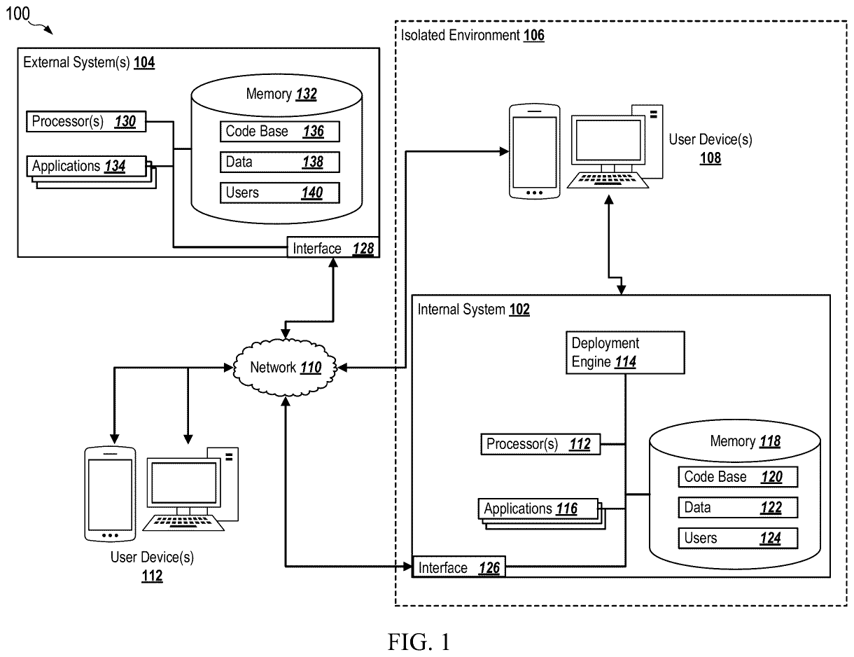

FIG. 1 illustrates a block diagram of an example system 100 for automated deployment of software in an isolated network. The system 100 includes an internal system 102 that executes in an isolated environment 106, and one or more external systems 104 that communicate using a network 110. Additionally, user devices 108 and 112 internal to and external from the isolated environment 106 can interact with external system 104 and the internal system 102.

The isolated environment 106, can act as a protective firewall, or shield between the internal system 102 and the remainder of the network 110 or internet at large. In some implementations, the isolated environment 106 is a virtual private cloud (VPC). In general, the isolated environment 106 can be a virtualized system or network that provides an isolated and secure environment within a shared public network infrastructure. It can permit organizations or internal system 102 to create and manage their own virtual and/or physical network resources, such as subnets, routing tables, and network gateways, as if they were operating within a unique private data center. This level of control and isolation provides enhanced security and flexibility for businesses to deploy and manage their applications and data in the cloud according to their specific needs and compliance or regulatory requirements.

Internal system 102 can be designed to receive deployment requests from external systems 104 and deploy them within the isolated environment 106 without sacrificing the security and isolation created by the isolated environment 106. Internal system 102 includes one or more processors 112, a deployment engine 114, applications 116, and a memory 118.

Memory 118 can represent a single memory or multiple memories. The memory 118 can include any memory or database module and can take the form of volatile or non-volatile memory including, without limitation, magnetic media, optical media, random access memory (RAM), read-only memory (ROM), removable media, or any other suitable local or remote memory component. The memory 118 can store various objects or data, including digital asset data, public keys, user and/or account information, administrative settings, password information, caches, applications, backup data, repositories storing business and/or dynamic information, and any other appropriate information associated with the internal system 102, including any parameters, variables, algorithms, instructions, rules, constraints, or references thereto. In some implementations, memory 118 stores a code base 120, data 122, and user information 124. Additionally, the memory 118 can store any other appropriate data, such as VPN applications, firmware logs and policies, firewall policies, a security or access log, print or other reporting files, as well as others. While illustrated within the system 100, memory 118 or any portion thereof, including some or all of the particular illustrated components, can be located remote from the internal system 102 in some instances, including as a cloud application or repository or as a separate cloud application or repository when the internal system 102 itself is a cloud-based system.

Code base 120 can be a repository of code, libraries, or other elements for running and maintaining applications 116 within the internal system 102. In some implementations, the code base 120 includes certain functions, libraries, or code that has been previously approved for execution within the isolated environment 106.

User Information 124 can include account information, credentials (e.g., username and password, or biometrics, etc.) user preferences, and other details generally related to users of the internal system 102. In some implementations, the user information 124 is anonymized or has certain sensitive information (e.g., addresses, payment accounts, etc.) masked or encrypted to ensure user privacy is maintained.

Each of the one or more processors 112 can be a central processing unit (CPU), an application specific integrated circuit (ASIC), a field-programmable gate array (FPGA), or another suitable component. Generally, the processor 112 executes instructions and manipulates data to perform the operations of the internal 102. Specifically, the processor 112 executes the algorithms and operations described in the illustrated figures, as well as the various software modules and functionality, including the functionality for sending communications to and receiving transmissions from network 110, user devices 108, as well as to other devices and systems. Each processor 112 can have a single or multiple cores, with each core available to host and execute an individual processing thread. Further, the number of, types of, and particular processors 112 used to execute the operations described herein can be dynamically determined based on a number of requests, interactions, and operations associated with the internal system 102.

Regardless of the particular implementation, “software” includes computer-readable instructions, firmware, wired and/or programmed hardware, or any combination thereof on a tangible medium (transitory or non-transitory, as appropriate) operable when executed to perform at least the processes and operations described herein. In fact, each software component can be fully or partially written or described in any appropriate computer language including C, C++, JavaScript, Java™, Visual Basic, assembler, Perl®, any suitable version of 4GL, as well as others.

Applications 116 can be software of firmware programs that run within the isolated environment 106. Applications 116 can access the memory 118 and read/write data 122 or perform actions, calls, and executions referencing code base 120. In some implementations, applications 116 generally are approved before deployment, and have limited capability when interacting with network 110 or external system 104. In some implementations, a specific list of approved communications or messages is provided, and any attempted message that is not on the specific list is blocked, or otherwise prevented from leaving the interface 126, and the offending application 116 can be flagged for review, uninstalled, or limited in its functionality.

Interface 126 can be used by the internal system 102 to communicate with other systems in a distributed environment-including within the system 100—connected to the network 110 (e.g., external systems 104, user devices 112, 108, and other systems communicably coupled to the illustrated internal system 102 and/or network 110. Generally, the interface 126 includes logic encoded in software and/or hardware in a suitable combination and operable to communicate with the network 110 and other components. More specifically, the interface 126 can include software supporting one or more communication protocols associated with communications such that the network 110 and/or interface's 126 hardware is operable to communicate physical signals within and outside of the illustrated system 100. Still further, the interface 126 can allow the internal system 102 to perform the operations described herein. In some implementations, interface 126 includes one or more firewalls or watchdog applications that monitor incoming and outgoing network traffic to ensure compliance with isolated environment 106 regulations or requirements.

Network 110 facilitates wireless or wireline communications between the components of the system 100 (e.g., between the internal system 102, the external systems 104, the user devices 108, 112, etc.), as well as with any other local or remote computers, such as additional mobile devices, clients, servers, or other devices communicably coupled to network 110, including those not illustrated in FIG. 1. In the illustrated environment, the network 110 is depicted as a single network, but can comprise more than one network without departing from the scope of this disclosure, so long as at least a portion of the network 110 can facilitate communications between senders and recipients. In some instances, one or more of the illustrated components (e.g., the internal system 102, external systems 104, isolated environment 106, etc.) can be included within or deployed to network 110 or a portion thereof as one or more cloud-based services or operations. The network 110 can be all or a portion of an enterprise or secured network, while in another instance, at least a portion of the network 110 can represent a connection to the Internet. In some instances, a portion of the network 110 can be a virtual private network (VPN). Further, all or a portion of the network 110 can comprise either a wireline or wireless link. Example wireless links can include 802.11a/b/g/n/ac, 802.20, WiMax, LTE, and/or any other appropriate wireless link. In other words, the network 110 encompasses any internal or external network, networks, sub-network, or combination thereof operable to facilitate communications between various computing components inside and outside the illustrated system 100. The network 110 can communicate, for example, Internet Protocol (IP) packets, Frame Relay frames, Asynchronous Transfer Mode (ATM) cells, voice, video, data, and other suitable information between network addresses. The network 110 can also include one or more local area networks (LANs), radio access networks (RANs), metropolitan area networks (MANs), wide area networks (WANs), all or a portion of the Internet, and/or any other communication system or systems at one or more locations.

User devices 108 and 112 are computing devices or computers used by one or more users and developer of the software application to interact within system 100, respectively. For example, the user devices 108 can interact with the internal system 102 to review applications 116, performance data, or to approve or disapprove new deployments. In some cases, system 100 describes an enterprise computing environment, where the user devices 108 can analyze database objects (e.g., code base 120, data 122, etc.).

As used in the present disclosure, the term “computer” or “computing devices” is intended to encompass any suitable processing device. For example, the user devices 108 and 112 can be any computer or processing device such as, for example, a blade server, general-purpose personal computer (PC), Mac® workstation, UNIX-based workstation, or any other suitable device. In other words, the present disclosure contemplates computers other than general-purpose computers, as well as computers without conventional operating systems.

Similarly, the user devices 108 and 112 can be any system that can request data and/or interact with the internal system 102 or external systems 104. The user devices 108 and 112, in some instances, can be desktop systems, a client terminal, or any other suitable device, including a mobile device, such as a smartphone, tablet, smartwatch, or any other mobile computing device. In general, each illustrated component can be adapted to execute any suitable operating system, including Linux, UNIX, Windows, Mac OS®, Java™, Android™, Windows Phone OS, or iOS™, among others. The user devices 108 and 112 can include one or more specific applications executing on the user devices 108 and 112, or the user devices 108 and 112 can include one or more Web browsers or web applications that can interact with particular applications executing remotely from the user devices 108 and 112.

The deployment engine 114 can be responsible for updating, confirming, and deploying new applications 116 from external systems 104. External system 104 can be separate computing systems executing in their own isolated computing environments (not shown), or with open access to the network 110. External system 104 can include processors 130, which can be similar to processors 112, as well as a memory 132 storing a code base 136, data 138, user information 140 and other things. Applications 134, developed in external to the isolated environment 106 are in some instances required or desired to be deployed as applications 116. For example, in some instances the external systems 104 and internal system 102 are identical but operate excluded from each other because of the isolated environment 106. Deployment engine 114 can receive a deployment request and candidate application from applications 134 to deploy as an application 116 in the internal system 102. In some implementations, the deployment engine 114 can be used to migrate data 138 to data 122, or portions of code base 136 to code base 120, among other things.

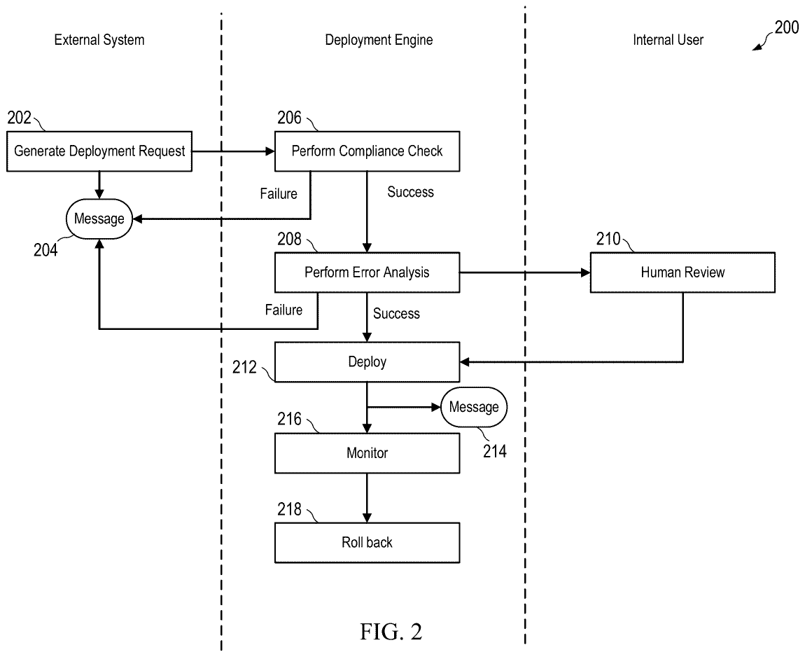

The deployment engine 114 can include a rules engine, scripts and programming, and or one or more AI models (e.g., deep learning neural networks) that enable it to receive software applications and code, scan it, and provide scan results. The deployment engine 114 can further message the external systems 104, user devices 108 and 112, or other applications 116 to facilitate communications on status of deployment. In some implementations, deployment engine 114 receives requests to deploy software in the isolated environment 106 and performs operations as described below in FIG. 2 in order to deploy the software in internal system 102.

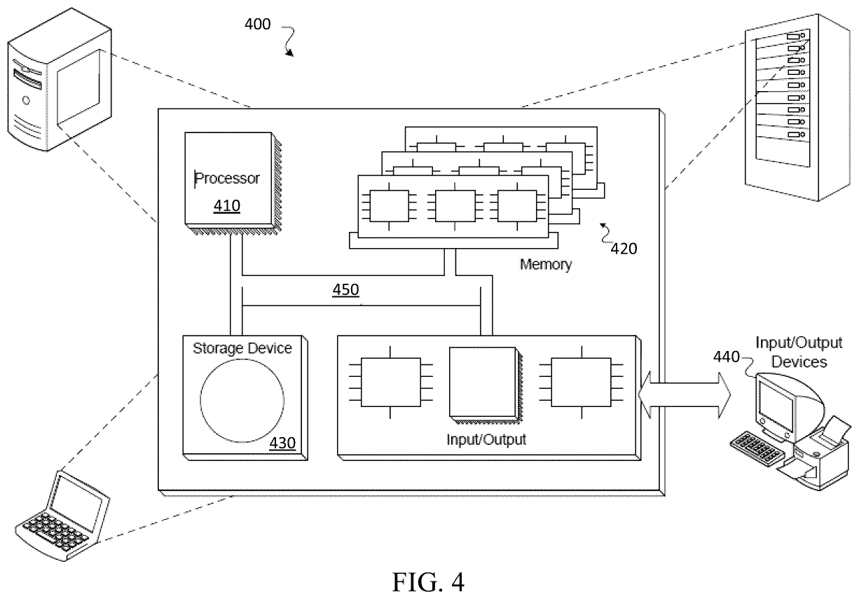

FIG. 2 is a flowchart illustrating an example process 200 for automated deployment of software (or code) in an isolated computing environment. The operations of process 200 can be performed, for example, based on the system described with respect to FIG. 1, or in another manner. The operations shown in process 200 may not be exhaustive and that other operations can be performed as well before, after, or in between any of the illustrated operations. Further, some of the operations may be performed simultaneously, or in a different order than shown in FIG. 2. In some implementations, some of the operations may be performed by a computer, or multiple computers. The one or more computers the process 200 will be described as being performed by a system of, located in one or more locations, and programmed appropriately in accordance with this specification. For example, one or more of a computation system 400 of FIG. 4, appropriately programmed, can perform the process 200. As another example, one or more computer in the example system 100 (e.g., the internal system 102), when appropriately programmed, can perform the process 200.

At 202, a deployment request is generated by an external system such as external system 104 of FIG. 1. The deployment request can be a request to deploy candidate code in an isolated computing environment such as the isolated computing environment 106 of FIG. 1. In some implementations, the candidate code can include one or more of a particular application, suite of applications, code base, table base, or other software. In some implementations, the deployment request includes uncompiled or uninterpreted code to be deployed. In some implementations the deployment request further includes a list of dependencies and metadata. Dependencies can be other software or data that must also be deployed in the computing environment and metadata can be information about the application or software to be deployed itself.

At 204, a message can be sent to notify developers or system managers of the candidate code or systems requesting deployment that a deploy request has been submitted. In some implementations, the message is sent to a messaging system such as Discord, Slack, Lark, email, or other service.

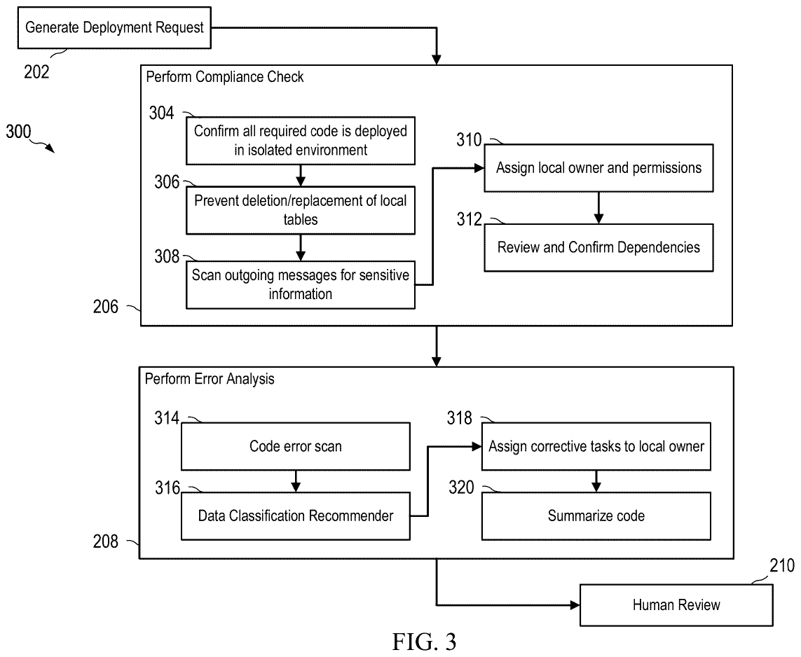

At 206, the deployment engine receives the deployment request and the candidate code to be deployed and performs a compliance check. In general, the compliance check ensures that the code satisfies any regulatory requirements and will operate within the isolated computing environment without compromising the data or information within the isolated environment. The compliance check is discussed in more detail below with regard to FIG. 3. The deployment engine can search the candidate code to be deployed, identify function calls, messages sent, data read and writes, and/or other parameters to identify compliance issues. In some implementations, the compliance check 206 can verify that all the required dependencies for the software exist in the isolated computing environment. If a required dependency is not present, the deployment engine can request the deployment of that dependency, restarting process 200 to deploy the dependency before returning to the candidate code at hand.

At 208, an error analysis is performed. In some implementations, the error analysis generally can include a debugging analysis of the software. The error analysis can identify issues that may arise when deploying the software in the isolated computing environment, in particular, where there may not have been such issues when deployed outside the isolated computing environment. In some implementations, the error analysis identifies particular portions or lines of code that are likely to cause errors. Additionally, the deployment engine can generate a summary of the software or portions of the software to focus or enhance human review. The error analysis is discussed in more detail below with regard to FIG. 3.

At 210, after completing compliance and error analysis, the deployment engine can send the software, and a report associated with the software detailing the results of the compliance check and the error analysis to a human reviewer. For example, the report for human review can indicate that the code fails compliance checks because it writes data to tables external to the isolated environment. In some implementations, 210 can be skipped, and the process is fully automatic, for example, if a compliance check or error analysis results in a failure, the deployment engine returns a message to the external system and process 100 ceases. In some implementations, a human reviewer can analyze the software in light of the error analysis and compliance check, resolve any outstanding issues, and then approve the software for deployment. In some implementations, the human review is required by regulation or law.

At 212, upon satisfactory compliance and error checks, and/or approval of the human review, the deployment engine can deploy the software. Deploying the software can involve replacing outdated software with newer software or deploying an entirely new piece of software. Deployment can include building the software from source code, performing testing to ensure functionality, stability, and security, and so on. The software can then be packaged into a deployable format, such as a container or an installation file. In some implementations, the deployment process can occur using automated deployment tools such as a continuous integration/continuous deployment (CI/CD) pipeline, which automates the build, test, and deployment process.

At 214, in response to a successful deployment, a message is sent to a local user within the isolated computing environment notifying the new owner, e.g., the user within the isolated computing environment that has ownership and permissions of the software, of the software that their software has been deployed. In some implementations, a message is also sent to the external system, indicating that the deployment request has been satisfied.

At 216, the deployment engine can monitor operation of the newly deployed software. This can include, for example, intercepting or observing network traffic to verify compliance, as well as scanning and searching error logs associated with the software.

At 218, In some implementations, if the deployment fails, or there are significant errors during runtime when the software is deployed, the deployment engine can uninstall the software. In some implementations, the deployment engine can re-install a prior version of the software that was previously deployed, or otherwise roll back to a known stable state.

FIG. 3 is a flowchart illustrating an example process 300 for performing compliance checks and error analysis of candidate code. Upon receipt of the deployment request from 202, the compliance check can begin in 206 as illustrated above with respect to FIG. 2. Although FIGS. 2 and 3 show that the compliance check 206 is performed before the error analysis 208, In some implementations, the error analysis 208 can be performed before or in parallel with the compliance check 206. Similarly, the operations shown in process 300 may not be exhaustive and that other operations can be performed as well before, after, or in between any of the illustrated operations. Additionally, some operations can occur multiple times iteratively, or not at all when they do not apply. Process 300 is merely an example and should not be interpreted as limiting. In some implementations, operations occurring within compliance checks 206 can instead occur as part of the error analysis 208. Similarly, operations occurring in 208 can instead occur in 206 in certain instances.

At 304, a check is performed to confirm that the code to be deployed will operate within the isolated environment. That is, the target deployment region can be identified from the request, and the compliance check can confirm that each table read or write location, dependency location, and data destination is within the target deployment region. In some implementations, the check is performed by verifying uniform resource locators (URLs) within the code. In some implementations, memory pointers, metadata, or other indicators are used to ensure the code, when deployed, will execute entirely within the isolated environment.

At 306, a check is performed to confirm that the code does not delete, replace, or remove data from tables within the isolated environment. In some implementations, this includes performing a scan of the function calls and target write operations and comparing them to a pre-approved list of write operations. If a function writes to a table or deletes data that is not pre-approved, or in a non-approved manner, this check can indicate the code fails. In some implementations all read and write operations can be required to be performed in a specific format (e.g., SQL commands).

At 308, any outgoing message traffic that the code will generate is scanned to ensure it does not include sensitive information. Sensitive information can include, for example, personally identifiable information (PII), usage data, usernames and passwords, or others. In some implementations, outgoing messages are compared to a “whitelist” or “approved list” and only matching messages are permitted. In some implementations, data can be masked or truncated before it is sent to avoid transmission of sensitive data.

At 310, a check is performed to identify a developer, user, or process that will have ownership and permissions over the code to be deployed. If no developer within the isolated environment is currently assigned, the deployment engine can assign one. This ensures that future error reports, development, and management can be maintained for the deployed application once it is within the isolated computing environment. In addition to assigning ownership, permissions can be assigned, for example read, edit, suggest, modify, etc. for each portion of code. Further, the new owner can be given access or permissions related to dependencies for the code that may have been previously deployed within the isolated computing environment.

At 312, the deployment engine can review the dependencies associated with the code and ensure they are all present or deployed in the isolated computing environment. In some implementations, the dependencies can be included in the deployment request, or in the source code itself. If a dependency, or compatible equivalent, is not present in the isolated computing environment, then the deployment ending can request that the dependency be imported or deployed in a separate request within the isolated computing environment.

Upon completion of the compliance check 206, process 300 continues in an error analysis 208. At 314, an error scan is performed for the code. In some implementations, the error scan includes static analysis techniques, where the code is examined without actually executing it. Tools such as linters, compilers, and specialized code analysis software can be used to scan the code for syntax errors, semantic errors, potential security flaws (like buffer overflows or SQL injection), and adherence to coding standards and best practices. The error scan can review code patterns, data flow, and control flow to detect anomalies and flag potential issues that could lead to bugs, crashes, or security breaches.

At 316, a data classification recommendation can be provided. In some implementations, any data handled by the code, and the code or portions of the code itself is analyzed and a recommended classification for the data generated. This recommended classification can be included in the report to be sent for human review at 210. Data or code portions can be classified based on a level of compliance risk, security risk, and/or stability risk. In some implementations, a tiered classification system is used. For example, tier one can include public information, tier two can be company internal information, tier three can include manager level or restricted access information, and tier for can be a maximum-security tier with, for example, personal information, user information, passwords, etc. In some implementations, an AI model, such as a large language model, or deep learning neural network can parse the code and generate classification.

At 318, any identified errors, security risks, or classification problems, as well as any compliance concerns from 206, can be assigned to a local owner within the isolated computing environment. This enables the generation of support tickets, and resolution of issues.

At 320, a code summary can be generated. In some implementations, this is performed by providing the code, or portions of the code, as input to a generative AI model. For example, the code can be provided in a prompt to a large language model (e.g., GPT, Claude, Gemini, Grok, etc.) and receive a summary of the purpose of the code (or portion of code), certain areas of code that need review, what has changed since previous versions, and other things. In some implementations the code summary is designed to assist the human reviewer in accurately and quickly reviewing the code.

FIG. 4 illustrates a schematic diagram of an example computing system 400. The system 400 can be used for the operations described in association with the implementations described herein. For example, the system 400 may be included in computing devices of the one or more online components and/or the one or more offline components. The system 400 includes a processor 410, a memory 420, a storage device 430, and an input/output device 440, which are interconnected using a system bus 450. The processor 410 is capable of processing instructions for execution within the system 400. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship with each other. In some implementations, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, such operations are not required to be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations are not required in all implementations, and the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described example implementations but should be defined only in accordance with the following claims and their equivalents. Accordingly, other implementations also are within the scope of the claims.

What is claimed is:

1. A method comprising:
identifying a deployment request, the deployment request comprising candidate code for deployment in an isolated computing environment;
performing a compliance check on the candidate code;
performing an error analysis on the candidate code;
identifying approved candidate code; and
deploying the candidate code in the isolated computing environment.

2. The method of claim 1, wherein the isolated computing environment comprises a virtual private cloud (VPC).

3. The method of claim 1, comprising:
submitting the candidate code to a human review process, wherein identifying the approved candidate code comprises receiving the approved candidate code from the human review process.

4. The method of claim 1, comprising:
identifying a second deployment request, the second deployment request comprising second candidate code for deployment in the isolated computing environment;
performing a second compliance check on the second candidate code; and
in response to the second compliance check failing:
sending a message to a requesting system associated with the second deployment request, the message indicating a reason for the second compliance check failing;
receiving an updated second candidate code for deployment in the isolated computing environment; and
performing a third compliance check on the updated second candidate code.

5. The method of claim 1, wherein the compliance check comprises:
performing a scan of the candidate code to verify the candidate code will execute entirely within the isolated computing environment, and the scan comprises a search for at least one of uniform resource locators (URLs), table locations, task locations, dependency locations, or target data destinations.

6. The method of claim 1, wherein the compliance check comprises:
performing a scan of the candidate code to verify the candidate code does not perform update, replacement, or deletion operations on existing data within the isolated computing environment.

7. The method of claim 1, wherein the compliance check comprises:
performing a scan of the candidate code to identify a message that the candidate code will send outside of the isolated computing environment; and
verifying that the messages that the code will send only comprises approved information.

8. The method of claim 7, wherein the approved information comprises aggregated, anonymized user data.

9. The method of claim 1, wherein the compliance check comprises:
identifying a user within the isolated computing environment;
assigning the user within the isolated computing environment ownership of the candidate code;
granting the user within the isolated computing environment permissions associated with the candidate code; and
granting the user within the isolated computing environment permissions associated with dependencies of the candidate code.

10. The method of claim 1, wherein the compliance check comprises:
identifying one or more dependencies on which the candidate code relies;
determining that at least one of the one or more dependencies is not present in the isolated computing environment; and
for each particular dependency not present in the isolated computing environment:
submitting a deployment request for the particular dependency.

11. The method of claim 1, wherein the error analysis comprises:
performing a scan of the candidate code for errors;
identifying at least one deployment task requiring user input and assigning the task to a user within the isolated computing environment;
identifying data that the candidate code will produce and generating a classification recommendation for the identified data; and
generating a deployment summary identifying portions of the candidate code that are distinct from pre-approved code.

12. The method of claim 1, comprising after deploying the candidate code in the isolated computing environment:
identifying a runtime failure of the deployed code;
reverting the deployed code to a pre-deployment state; and
sending a notification to an entity sending the deployment request, the notification indicating the runtime failure.

13. One or more computer-readable storage media storing one or more instructions that, when executable by one or more computers, cause the one or more computers to perform operations comprising:
identifying a deployment request, the deployment request comprising candidate code for deployment in an isolated computing environment;
performing a compliance check on the candidate code;
performing an error analysis on the candidate code;
identifying approved candidate code; and
deploying the candidate code in the isolated computing environment.

14. The computer-readable storage media of claim 13, wherein the isolated computing environment comprises a virtual private cloud (VPC).

15. The computer-readable storage media of claim 13, the operations comprising:
submitting the candidate code to a human review process, wherein identifying the approved candidate code comprises receiving the approved candidate code from the human review process.

16. The computer-readable storage media of claim 13, the operations comprising:
identifying a second deployment request, the second deployment request comprising second candidate code for deployment in the isolated computing environment;
performing a second compliance check on the second candidate code; and
in response to the second compliance check failing:
sending a message to a requesting system associated with the second deployment request, the message indicating a reason for the second compliance check failing;
receiving an updated second candidate code for deployment in the isolated computing environment; and
performing a third compliance check on the updated second candidate code.

17. A computer-implemented system, comprising:
one or more computers; and
one or more computer memory devices interoperably coupled with the one or more computers and having computer-readable storage media storing one or more instructions that, when executed by the one or more computers, perform one or more operations comprising:
identifying a deployment request, the deployment request comprising candidate code for deployment in an isolated computing environment;
performing a compliance check on the candidate code;
performing an error analysis on the candidate code;
identifying approved candidate code; and
deploying the candidate code in the isolated computing environment.

18. The system of claim 17, wherein the isolated computing environment comprises a virtual private cloud (VPC).

19. The system of claim 17, the operations comprising:
submitting the candidate code to a human review process, wherein identifying the approved candidate code comprises receiving the approved candidate code from the human review process.

20. The system of claim 17, the operations comprising:
identifying a second deployment request, the second deployment request comprising second candidate code for deployment in the isolated computing environment;
performing a second compliance check on the second candidate code; and
in response to the second compliance check failing:
sending a message to a requesting system associated with the second deployment request, the message indicating a reason for the second compliance check failing;
receiving an updated second candidate code for deployment in the isolated computing environment; and
performing a third compliance check on the updated second candidate code.
